(19) United States
(12) Patent Application Publication
(10) Pub. No.: US 2023/0073956 A1
(43) Pub. Date: Mar. 9, 2023

(54) SYSTEMS AND METHODS FOR EVALUATING USER REVIEWS

(71) Applicant: HERE GLOBAL B.V., ENDHOVEN (NL)

(72) Inventors: LEON STENNETH, CHICAGO, IL (US); JEROME BEAUREPAIRE, BERLIN (DE); JEREMY MICHAEL YOUNG, CHICAGO, IL (US)

(21) Appl. No.: 17/468,302

(22) Filed: Sep. 7, 2021

(51) Int. Cl. G06Q 30/02; G01C 21/34; G01C 21/36

(52) U.S. Cl. CPC G06Q 30/0282; G01C 21/3438; G01C 21/3492; G01C 21/3691

(57) ABSTRACT

Systems and methods for evaluating a review of a passenger trip are provided. For example, a method of evaluating a review of a passenger trip includes analyzing a review of a passenger trip in a vehicle. The method also includes receiving sensor data that corresponds to the passenger trip. The method also includes determining a score of the review based on the received sensor data and the analysis of the review.

### TECHNICAL FIELD

The present disclosure relates generally to user reviews, and more specifically to systems and methods for evaluating user reviews regarding passenger trips.

### BACKGROUND

User reviews are an invaluable asset to any business which interacts with individuals via the Internet. More recently, reviews have become an industry unto themselves, with many third-party customer review companies being created where individuals can post reviews of their experiences. Despite the potential benefits, some user reviews, may not be accurate and therefore have the potential to mislead an individual about various services.

### BRIEF SUMMARY

The present disclosure overcomes the shortcomings of prior technologies. In particular, a novel approach for evaluating a review of a passenger trip is provided, as detailed below.

In accordance with an aspect of the disclosure, a method for evaluating a review of a passenger trip is provided. The method includes analyzing a review of a passenger trip in a vehicle. The method also includes receiving sensor data that corresponds to the passenger trip. The method also includes determining a score of the review based on the received sensor data and the analysis of the review.

In accordance with another aspect of the present disclosure, a non-transitory computer-readable storage medium is provided. The non-transitory computer-readable storage medium includes one or more sequences of one or more instructions for execution by one or more processors of a device. The one or more instructions which, when executed by the one or more processors, cause the device to analyze a review of a passenger trip in a vehicle. The one or more instructions further cause the device to receive traffic data or route data, or a combination thereof, based on the analysis of the review. The one or more instructions further cause the device to determine a score of the review based on the traffic data or the route data, or the combination thereof, and the analysis of the review.

In accordance with another aspect of the disclosure, an apparatus for evaluating a review of a passenger trip is provided. The apparatus includes a processor. The apparatus also includes a memory comprising computer program code for one or more programs. The memory and the computer program code are configured to cause the processor of the apparatus to receive a review of a passenger trip in a vehicle. The computer program code is further configured to cause the processor of the apparatus to determine a score of the review of the passenger trip in the vehicle. The computer program code is further configured to cause the processor of the apparatus to provide for a display of the score of the review of the passenger trip.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of evaluating a review of a passenger trip, in accordance with aspects of the present disclosure;

FIG. 2 is a diagram of a geographic database, in accordance with aspects of the present disclosure;

FIG. 3 is a diagram of the components of a data analysis system, in accordance with aspects of the present disclosure;

FIG. 4 is a flowchart setting forth steps of an example process, in accordance with aspects of the present disclosure;

FIG. 5 is a flowchart setting forth steps of another example process, in accordance with aspects of the present disclosure;

FIG. 6 is a flowchart setting forth steps of another example process, in accordance with aspects of the present disclosure;

FIG. 7 is a diagram of an example computer system, in accordance with aspects of the present disclosure;

FIG. 8 is a diagram of an example chip set, in accordance with aspects of the present disclosure; and

FIG. 9 is a diagram of an example mobile device, in accordance with aspects of the present disclosure.

### DESCRIPTION OF SOME EMBODIMENTS

Examples of a method, apparatus, and a non-transitory computer-readable storage medium for evaluating a review of a passenger trip are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

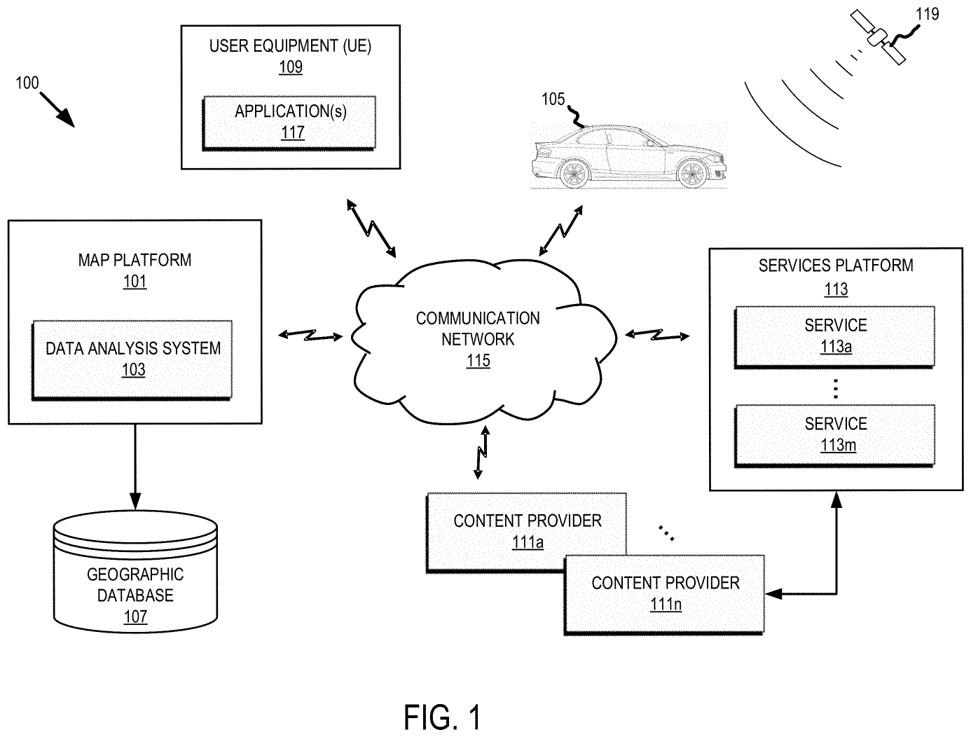

FIG. 1 is a diagram of a system 100 capable of evaluating a review of a passenger trip, according to one embodiment. In one embodiment, the system 100 receives a review of a passenger trip in a vehicle. In one example, the review of the passenger trip is completed as a result of the passenger submitting the review via an electronic device (e.g., smartphone, laptop, desktop, a tablet coupled to a vehicle, etc.). In one example, the review can be based on multiple scores such as a motion score, a safety score, and an agreements score. In one example, the system 100 is configured to evaluate if the review of the passenger trip is subjective to one or more biases from the passenger. For example, a passenger that is tired may not provide the same assessment of a trip at a different time when the passenger is not tired. In another example, a passenger may be more likely to give a more favorable review if the passenger is not heading towards a stressful scenario. To evaluate the review of the passenger trip, the system 100 is configured to receive data that corresponds to the passenger trip and evaluate the review based on an analysis of the data.

The vehicle may be a standard gasoline powered vehicle, a hybrid vehicle, an electric vehicle, a fuel cell vehicle, and/or any other mobility implement type of vehicle. The vehicle includes parts related to mobility, such as a powertrain with an engine, a transmission, a suspension, a driveshaft, and/or wheels, etc. The autonomous vehicle may be a manually controlled vehicle, semi-autonomous vehicle (e.g., some routine motive functions, such as parking, are controlled by the vehicle), or an autonomous vehicle (e.g., motive functions are controlled by the vehicle without direct driver input).

In one example, the system 100 may receive the position data and corresponding times of when a vehicle arrived at a pickup location and a drop-off location. Based on the position data and the corresponding times, the system 100 may be configured to determine that the vehicle performed according as expected. In this example, the system 100 is configured to assign a score of the review of the passenger trip based on the review and the analysis of the data. Continuing with this example, if a passenger submitted a negative review of trip, then the system 100 would assign a low score to the review based on the vehicle performing as expected and the discrepancy associated with a negative review from the passenger. However, if the passenger submitted a positive review of the trip, then the system 100 would assign a high score to the review based on the vehicle performing as expected and the correlation associated with a positive review from the passenger.

In another example, the system 100 may receive the position data and corresponding times of when a vehicle arrived at a pickup location and a drop-off location. Based on the position data and the corresponding times, the system 100 may be configured to determine that the vehicle did not perform as expected. In this example, the system 100 is configured to assign a score of the review of the passenger trip based on the review and the analysis of the data. Continuing with this example, if a passenger submitted a negative review of trip, then the system 100 would assign a high score to the review based on the vehicle not performing as expected and the correlation associated with the negative review from the passenger. However, if the passenger submitted a positive review of the trip, then the system 100 would assign a low score to the review based on the vehicle not performing as expected and the discrepancy associated with the positive review from the passenger.

In one embodiment, the system 100 is configured to analyze a review of a passenger trip in an autonomous vehicle. In this embodiment, the system 100 may be configured to receive sensor data that corresponds to the passenger trip. In one example, the sensor data may be provided to the system 100 based on data captured via one or more sensors of the vehicle. For example, the system 100 may be configured to receive acceleration data from an accelerometer coupled to the autonomous vehicle in addition to Light Detection and Ranging (LIDAR) data from a LIDAR sensor coupled to the autonomous vehicle. In this example, the system 100 may be configured to determine whether or not any sudden accelerations of the autonomous vehicle were necessary based on objects (e.g., people, vehicles, obstructions) that were detected through the LIDAR sensor. The system 100 may be configured to determine a score of the review based on the received sensor data and the analysis of the review.

The autonomous level of a vehicle can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In one embodiment, user equipment (e.g., a mobile phone, a portable electronic device, etc.) may be integrated in the vehicle, which may include assisted driving vehicles such as autonomous vehicles, highly assisted driving (HAD), and advanced driving assistance systems (ADAS). Any of these assisted driving systems may be incorporated into the user equipment. Alternatively, an assisted driving device may be included in the vehicle.

The term autonomous vehicle may refer to a self-driving or driverless mode in which no passengers are required to be on board to operate the vehicle. An autonomous vehicle may be referred as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate and respond to lane marking indicators (lane marking type, lane marking intensity, lane marking color, lane marking offset, lane marking width, or other characteristics) and driving commands or navigation commands.

In one embodiment, the vehicle may be an HAD vehicle or an ADAS vehicle. An HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In another embodiment, the system 100 is configured to analyze a review of a passenger trip in an autonomous vehicle. In this embodiment, the system 100 may be configured to receive sensor data and traffic data that corresponds to the passenger trip. In one example, the sensor data may be provided to the system 100 based on data captured via one or more image sensors of the vehicle. In this example, the traffic data may be provided to the system 100 based on data stored in one or more databases. For example, the system 100 may be configured to receive image data from a camera coupled to the autonomous vehicle and receive traffic delay information from a database. In this example, the system 100 may be configured to determine whether the traffic delay corresponded to all the lanes of a road based on an analysis of image data captured via an image sensor of the vehicle. The system 100 may be configured to determine a score of the review based on the received image data, traffic data, and the analysis of the review.

In one embodiment, the system 100 is configured to analyze a review of a passenger trip in an autonomous vehicle. In this embodiment, the system 100 may be configured to receive sensor data and route data that corresponds to the passenger trip. In one example, the sensor data may be provided to the system 100 based on data captured via a Global Positioning System (GPS) sensor of the vehicle. In this example, the route data may be provided to the system 100 based on data stored in one or more databases. For example, the system 100 may be configured to receive position data from a GPS sensor coupled to the autonomous vehicle and receive route information from a database. In this example, the system 100 may be configured to determine whether the autonomous vehicle followed a particular route based on the position data. The system 100 may be configured to determine a score of the review based on the received position data, route data, and the analysis of the review.

In another embodiment, the system 100 is configured to analyze a review of a passenger trip in an autonomous vehicle. In this embodiment, the system 100 may be configured to receive sensor data and weather data that corresponds to the passenger trip. In one example, the sensor data may be provided to the system 100 based on data captured via a speed sensor of the vehicle. In this example, the weather data may be provided to the system 100 based on data stored in one or more databases. For example, the system 100 may be configured to receive speed data from the speed sensor coupled to the autonomous vehicle and receive weather information from a database. In this example, the system 100 may be configured to determine whether the autonomous vehicle reduced a speed during the passenger trip based on weather conditions. The system 100 may be configured to determine a score of the review based on the received speed data, weather data, and the analysis of the review.

In one embodiment, the system 100 is configured to analyze a review of a passenger trip in an autonomous vehicle. In this embodiment, the system 100 may be configured to receive traffic data that corresponds to the passenger trip. In this example, the traffic data may be provided to the system 100 based on data stored in one or more databases. For example, the system 100 may be configured to receive traffic information from a database. In this example, the system 100 may be configured to determine how the traffic information could have impacted one or more aspects of operation of the autonomous vehicle during the passenger trip. The system 100 may be configured to determine a score of the review based on the received traffic data and the analysis of the review.

In another embodiment, the system 100 is configured to analyze a review of a passenger trip in an autonomous vehicle. In this embodiment, the system 100 may be configured to receive route data that corresponds to the passenger trip. In this example, the route data may be provided to the system 100 based on data stored in one or more databases. For example, the system 100 may be configured to receive traffic information from a database. In this example, the system 100 may be configured to determine if the best route was selected for the passenger trip. In one example, the best route is based on the fastest route. In another example, the best route is a route based on passenger preferences. The system 100 may be configured to determine a score of the review based on the received route data and the analysis of the review.

In one embodiment, the system 100 is configured to analyze a review of a passenger trip in an autonomous vehicle. In this embodiment, the system 100 may be configured to receive traffic data and route data that corresponds to the passenger trip. In this example, the traffic data and the route data may be provided to the system 100 based on data stored in one or more databases. In this example, the system 100 may be configured to determine what traffic conditions were associated with the route selected for the passenger trip. The system 100 may be configured to determine a score of the review based on the received traffic data, route data, and the analysis of the review.

In another embodiment, the system 100 is configured to analyze a review of a passenger trip in an autonomous vehicle. In this embodiment, the system 100 may be configured to receive traffic data, route data, and weather data that corresponds to the passenger trip. In one example, the traffic data, the route data, and the weather data may be provided to the system 100 based on data stored in one or more databases. In this example, the system 100 may be configured to determine what traffic conditions and weather conditions were associated with the route selected for the passenger trip. The system 100 may be configured to determine a score of the review based on the received traffic data, route data, weather data, and the analysis of the review.

In one embodiment, the system 100 is configured to analyze a review of a passenger trip in an autonomous vehicle. In this embodiment, the system 100 may be configured to receive traffic data, route data, and sensor data that corresponds to the passenger trip. In one example, the traffic data and the route data may be provided to the system 100 based on data stored in one or more databases. In this example, the sensor data may be provided to the system 100 based on sensor data captured via an electronic device of the passenger. The system 100 may be configured to determine a score of the review based on the received traffic data, route data, sensor data, and the analysis of the review.

In one embodiment, the system 100 is configured to receive a review of a passenger trip in a vehicle. In this embodiment, the system 100 may be configured to determine a score of the review of the passenger trip. Continuing with this embodiment, the system 100 may be configured to display a score of the review of the passenger trip. In one example, the score may be displayed in an application that is configured for selecting a vehicle for a passenger trip. In this example, the system 100 may be configured to receive, via one or more input devices, a selection of a vehicle based in part on the score of one of more reviews of passenger trips. For example, a user may request, through the application, to only display scores that are above a certain threshold. In the example, the user is given the option of deciding what vehicle to choose based on reviews of passenger trips that have been evaluated to be more accurate according to an analysis of the reviews and the data received (e.g., sensor data, traffic data, route data, weather data, etc.) that corresponds to the passenger trips.

Referring to FIG. 1, the map platform 101 can be a standalone server or a component of another device with connectivity to the communication network 115. For example, the component can be part of an edge computing network where remote computing devices (not shown) are installed along or within proximity of a given geographical area.

The communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map platform 101 may be a platform with multiple interconnected components. The map platform 101 may include multiple servers, intelligent networking devices, computing devices, components and corresponding software for generating information for evaluating a review of a passenger trip or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, information for evaluating a review of a passenger trip, location-based services, news services, etc. In one embodiment, the services platform 113 may interact with the map platform 101, and/or one or more content providers 111a-111n to provide the one or more services 113a-113m.

In one embodiment, the one or more content providers 111a-111n may provide content or data to the map platform 101, and/or the one or more services 113a-113m. The content provided may be any type of content, mapping content, textual content, audio content, video content, image content, etc. In one embodiment, the one or more content providers 111a-111n may provide content that may aid in evaluating a review of a passenger trip according to the various embodiments described herein. In one embodiment, the one or more content providers 111a-111n may also store content associated with the map platform 101, and/or the one or more services 113a-113m. In another embodiment, the one or more content providers 111a-111n may manage access to a central repository of data, and offer a consistent, standard interface to data.

By way of example, the user equipment (UE) 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for evaluating a review of a passenger trip. In another non-limiting example, application 117 may also be any type of application that is executable on the UE 109 and/or vehicle 105, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103 and perform one or more functions associated with evaluating a review of a passenger trip, either alone or in combination with the data analysis system 103.

In some embodiments, the UE 109 and/or the vehicle 105 may include various sensors for acquiring a variety of different data or information. For instance, the UE 109, and/or the vehicle 105 may include one or more camera/imaging devices for capturing imagery (e.g., terrestrial images), global positioning system (GPS) sensors or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109 and/or the vehicle 105 may also include one or more light sensors, height sensors, accelerometers (e.g., for determining acceleration and vehicle orientation), magnetometers, gyroscopes, inertial measurement units (IMUs), tilt sensors (e.g., for detecting the degree of incline or decline), moisture sensors, pressure sensors, and so forth. Further, the UE 109 and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109 and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109 and/or the vehicle 105.

By way of example, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

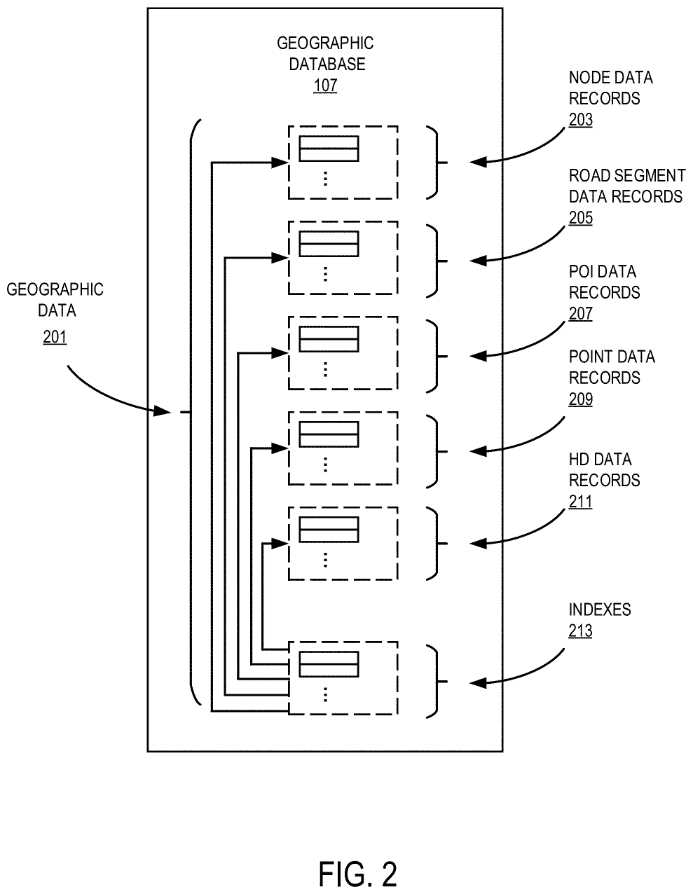

FIG. 2 is a diagram of the geographic database 107 of system 100, according to exemplary embodiments. In the exemplary embodiments, the information generated by the map platform 101 can be stored, associated with, and/or linked to the geographic database 107 or data thereof. In one embodiment, the geographic database 107 includes geographic data 201 used for (or configured to be compiled to be used for) mapping and/or navigation-related services, such as for personalized route determination, according to exemplary embodiments. For example, the geographic database 107 includes node data records 203, road segment data records 205, POI data records 207, point data records 209, HD data records 211, and indexes 213, for example. More, fewer or different data records can be provided. In one embodiment, other data records include cartographic (“carto”) data records, routing data, traffic data, weather data, and maneuver data. In one example, the other data records include data that is associated with certain POIs, roads, or geographic areas. In one example, the data is stored for utilization by a third-party. In one embodiment, the other data records include weather data records such as weather data reports. In another embodiment, the other data records include trip review data records. The trip review data records may include various aspects related to a trip. For example, the trip review data records may include aspects such as the vehicle type, the number of passengers, the duration of the trip, etc. In one embodiment, the other data records include traffic data records such as traffic data reports. For example, the weather data records or the traffic data records can be associated with any of the map features stored in the geographic database 107 (e.g., a specific road or link, node, intersection, area, POI, etc.) on which the weather data or traffic data was collected. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 205 are links or segments representing roads, streets, or paths, as can be used in the calculated route or recorded route information for determination of one or more personalized routes, according to exemplary embodiments. The node data records 203 are end points or vertices (such as intersections) corresponding to the respective links or segments of the road segment data records 205. The road segment data records 205 and the node data records 203 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 207. In one example, the POI data records 207 may include the hours of operation for various businesses. The geographic database 107 can also include data about places, such as cities, towns, or other communities, and other geographic features, such as bodies of water, mountain ranges, etc. Such place or feature data can be part of the POI data records 207 or can be associated with POIs or POI data records 207 (such as a data point used for displaying or representing a position of a city).

As shown in FIG. 2, the geographic database 107 may also include point data records 209 for storing the point data, map features, as well as other related data used according to the various embodiments described herein. In addition, the point data records 209 can also store ground truth training and evaluation data, machine learning models, annotated observations, and/or any other data. By way of example, the point data records 209 can be associated with one or more of the node data records 203, road segment data records 205, and/or POI data records 207 to support verification, localization or visual odometry based on the features stored therein and the corresponding estimated quality of the features. In this way, the point data records 209 can also be associated with or used to classify the characteristics or metadata of the corresponding records 203, 205, and/or 207. In one example, the

[symbol]

As discussed above, the HD data records 211 may include models of road surfaces and other map features to centimeter-level or better accuracy. The HD data records 211 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD data records 211 may be divided into spatial partitions of varying sizes to provide HD mapping data to vehicles and other end user devices with near real-time speed without overloading the available resources of these vehicles and devices (e.g., computational, memory, bandwidth, etc. resources). In some implementations, the HD data records 211 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD data records 211.

In one embodiment, the HD data records 211 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

The indexes 213 in FIG. 2 may be used improve the speed of data retrieval operations in the geographic database 107. Specifically, the indexes 213 may be used to quickly locate data without having to search every row in the geographic database 107 every time it is accessed. For example, in one embodiment, the indexes 213 can be a spatial index of the polygon points associated with stored feature polygons.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format (for example, accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

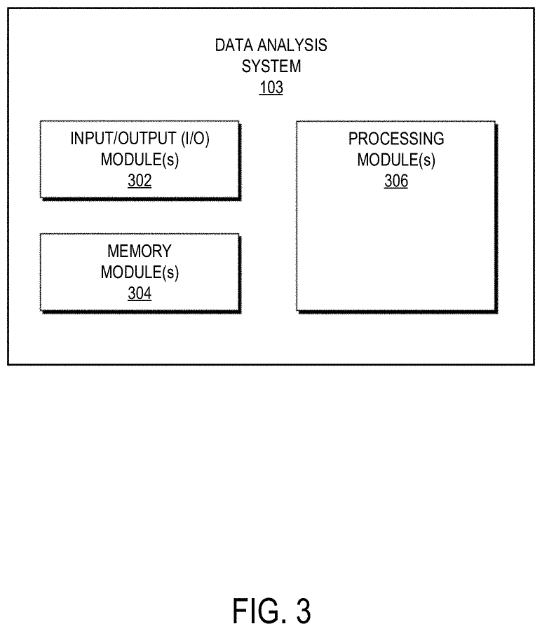

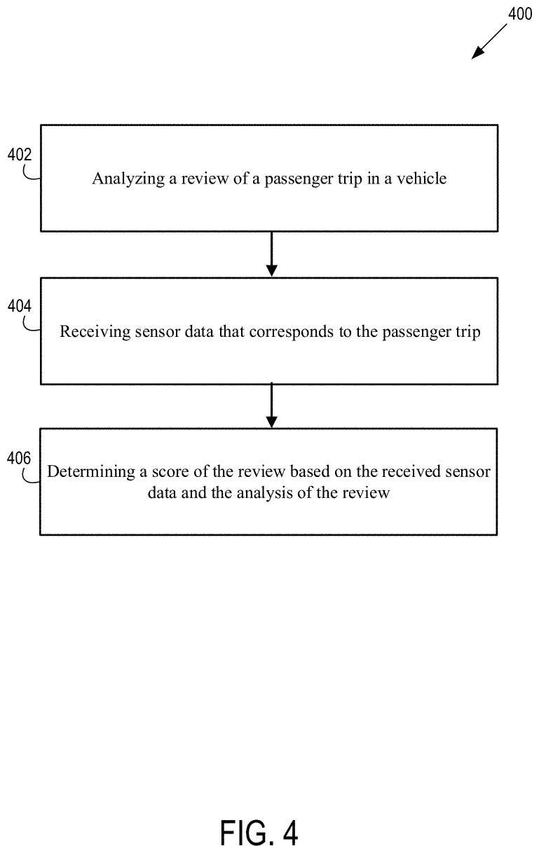

FIG. 3 is a diagram of the components of the data analysis system 103 of FIG. 1, according to one embodiment. By way of example, the data analysis system 103 includes one or more components for evaluating a review of a passenger trip according to the various embodiments described herein. It is contemplated that the functions of these components may be combined or performed by other components of equivalent functionality. In this embodiment, data analysis system 103 includes in input/output module 302, a memory module 304, and a processing module 306. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 302-306 may be implemented as a cloud-based service, local service, native application, or combination thereof. The functions of these modules are discussed with respect to FIGS. 4, 5, and 6 below.

FIGS. 4, 5, and 6 are flowcharts of example methods, each in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowcharts of FIGS. 4, 5, and 6 each show the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIGS. 4, 5, and 6 may represent circuitry that is wired to perform the specific logical functions in the process. Illustrative methods, such as those shown in FIGS. 4, 5, and 6, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIGS. 4, 5, and 6 may be fully performed by a computing device (or components of a computing device such as one or more processors), or may be distributed across multiple components of the computing device, across multiple computing devices, and/or across a server.

Referring first to FIG. 4, an example method 400 may include one or more operations, functions, or actions as illustrated by blocks 402-406. The blocks 402-406 may be repeated periodically or performed intermittently, or as prompted by a user, device or system. In one embodiment, the method 400 is implemented in whole or in part by the data analysis system 103 of FIG. 3.

As shown by block 402, the method 400 includes analyzing a review of a passenger trip in a vehicle. In one example, the input/output module 302 of FIG. 3 is configured to receive the review of the passenger trip in the vehicle. Continuing with this example, the processing module 306 of FIG. 3 is configured to receive the review from the input/output module 302 and analyze the review of the passenger trip in the vehicle. In one example, the review is manually completed by a passenger via an electronic device. In another example, the review is automatically completed without a passenger needing to enter any information manually. In this example, the review is based on passenger behavior during the passenger trip. For example, user emotions may be captured by wearable electronic devices and other vehicle sensors. The user emotions may be used to automatically fill in sections of a review template.

In one example, the review template includes various criteria used to review the passenger trip in the vehicle. In one example, the criteria include a motion criterion, a safety criterion, and an agreement criterion. The motion criterion may be based on how the vehicle drives during the passenger trip. The safety criterion may be based on how safe and comfortable it is for a passenger to board and deboard the vehicle. The agreement criterion may be based on requests (e.g., a pickup location, a drop-off location, a pickup time, etc.) from the passenger prior to the beginning of the passenger trip. In one example, the review template may be personalized for a passenger. For example, a passenger may want to review a passenger trip based on a motion criterion and an agreement criterion. In another example, a passenger may want to review a passenger trip based on a motion criterion, a safety criterion, and an agreement criterion. Based on the reviews given in each criterion, a multifaceted review for a vehicle may be provided to a user. For example, an autonomous vehicle may have several reviews for motion, several reviews for safety, and several reviews for agreements.

As shown by block 404, the method 400 also includes receiving sensor data that corresponds to the passenger trip. In one example, the input/output module 302 of FIG. 3 is configured to receive sensor data from one or more sensors associated with the system 100 of FIG. 1. In one example, the received sensor data may include a smoothness evaluation of vehicle operation, the rate of heading changes, the number of lanes switched, deceleration events, and accelerations events measured via one or more sensors. In one example, the one or more sensors may be coupled to the vehicle. In another example, the one or more sensors may be part of an electronic device that is not coupled to the vehicle. In one example, the one or more sensors may be distributed between the vehicle and an electronic device that is not coupled to the vehicle.

As shown by block 406, the method 400 also includes determining a score of the review based on the received sensor data and the analysis of the review. In one example, the sensor data includes one or more measurements of motion corresponding to operation of the vehicle during the passenger trip. In another example, the sensor data includes one or more measurements of safety corresponding to operation of the vehicle during the passenger trip. In one example, the sensor data is compared to the review of the passenger trip to determine a likelihood of one or more biases within the review. For example, if a passenger left a poor review for the motion criterion, then sensor data corresponding to the motion of the vehicle may be analyzed to determine whether the poor review is justified. In another example, if a passenger left a good review for the safety criterion, then sensor data corresponding how safe the vehicle operated during the passenger trip may be analyzed to determine whether the good review is justified. In one example, the input/output module 302 of FIG. 3 is configured to provide the score of the review for further processing. For example, the score of the review may be used as an input for filtering reviews associated with autonomous vehicles that are part of an available fleet for hire.

In one embodiment, the method 400 may further include receiving traffic data that corresponds to the passenger trip. In this embodiment, the method 400 may further include analyzing the traffic data based on the review of the passenger trip. Continuing with this embodiment, the method 400 may further include updating the determined score of the review based on the analysis of the traffic data. In another embodiment, the method 400 may further include receiving route data that corresponds to the passenger trip. In this embodiment, the method 400 may further include analyzing the route data based on the review of the passenger trip. Continuing with this embodiment, the method 400 may further include updating the determined score of the review based on the analysis of the route data. In one embodiment, the method 400 may further include receiving weather data that corresponds to the passenger trip. In this embodiment, the method 400 may further include analyzing the weather data based on the review of the passenger trip. Continuing with this embodiment, the method 400 may further include updating the determined score of the review based on the analysis of the weather data.

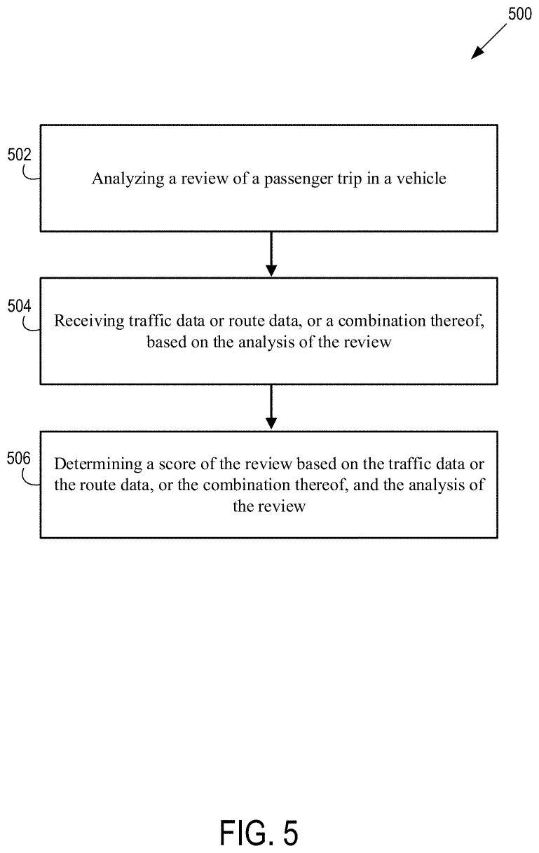

Referring to FIG. 5, the example method 500 may include one or more operations, functions, or actions as illustrated by blocks 502-506. The blocks 502-506 may be repeated periodically or performed intermittently, or as prompted by a user, device or system. In one embodiment, the method 500 is implemented in whole or in part by the data analysis system 103 of FIG. 3.

As shown by block 502, the method 500 includes analyzing a review of a passenger trip in a vehicle. Block 502 may be similar in functionality to block 402 of method 400. In one example, the input/output module 302 of FIG. 3 is configured to receive the review of the passenger trip in the vehicle and store the review in the memory module 304 of FIG. 3. In one example, the review is based on passenger behavior during the passenger trip. For example, the autonomous vehicle may be configured to capture video of the passenger during the passenger trip and automatically populate a review template based on one or more aspects of the captured video.

As shown by block 504, the method 500 also includes receiving traffic data or route data, or a combination thereof, based on the analysis of the review. In one example, the traffic data or the route data, or the combination thereof, may be analyzed to determine the accuracy of one or more parts of a review of a passenger trip. For example, the traffic data or the route data, or the combination thereof, may be used to assess the motion criterion, the safety criterion, and the agreement criterion, as described herein. In one example, the processing module 306 of FIG. 3 is configured to analyze the traffic data or the route data, or the combination thereof.

As shown by block 506, the method 500 also includes determining a score of the review based on the traffic data or the route data, or the combination thereof, and the analysis of the review. In one example, the traffic data may be analyzed to determine whether a component of the review corresponding to the motion of the vehicle during the passenger trip is accurate. In another example, the traffic data and the route data may be analyzed to determine whether a component of the review corresponding to the safety of a passenger boarding the vehicle is accurate. In one example, the route data may be analyzed to determine whether a component of the review corresponding to an agreement such as the vehicle arriving at a destination by a certain time was accurate.

In one embodiment, the method 500 may further include receiving weather data that corresponds to the passenger trip. In this embodiment, the method 500 may also include analyzing the weather data based on the review of the passenger trip. Continuing with this embodiment, the method 500 may also include updating the determined score of the review based on the analysis of the weather data. In another embodiment, the method 500 may further include receiving sensor data that corresponds to the passenger trip. In this embodiment, the method 500 may also include analyzing the sensor data based on the review of the passenger trip. Continuing with this embodiment, the method 500 may also include updating the determined score of the review based on the analysis of the sensor data. In one example, the sensor data includes one or more measurements of motion data that corresponds to an operation of the vehicle. In another example, the sensor data includes one or more measurements of safety data that corresponds to an operation of the vehicle.

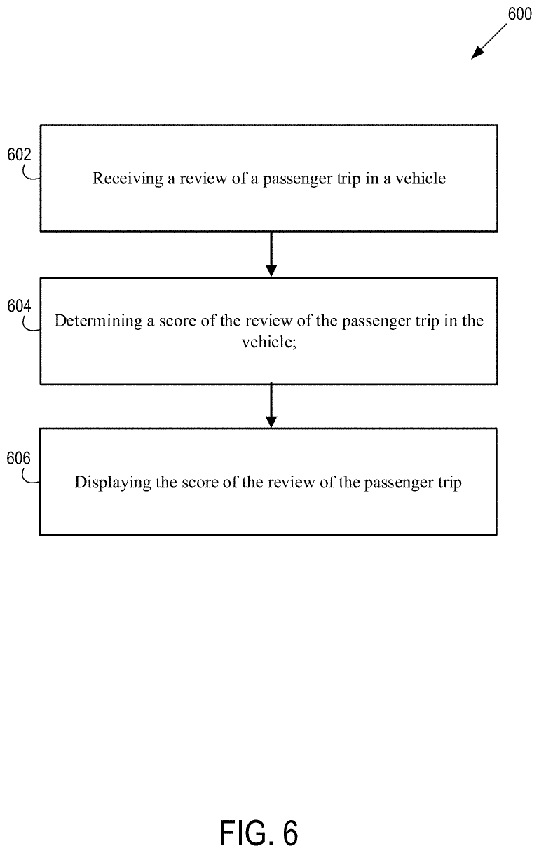

Referring to FIG. 6, the example method 600 may include one or more operations, functions, or actions as illustrated by blocks 602-606. The blocks 602-606 may be repeated periodically or performed intermittently, or as prompted by a user, device or system. In one embodiment, the method 600 is implemented in whole or in part by the data analysis system 103 of FIG. 3.

As shown by block 602, the method 600 includes receiving a review of a passenger trip in a vehicle. Block 502 may be similar in functionality to block 402 of method 400. In one example, the review is based on passenger behavior during the passenger trip. In one example, the input/output module 302 of FIG. 3 is configured to receive the review of the passenger trip in the vehicle and store the review in the memory module 304 of FIG. 3.

As shown by block 604, the method 600 also includes determining a score of the review of the passenger trip in the vehicle. In one example, the score of the review may be a numerical score in a range (e.g., 1-5, etc.). In another example, the score of the review may be a binary score (e.g., “Reliable” or “Unreliable”, etc.) that indicates the quality of the review of the passenger trip. In one example, the binary score may also be represented and displayed as a pair of images (e.g., a thumbs up and a thumbs down). In one example, the processing module 306 of FIG. 3 is configured to determine a score of the review of the passenger trip in the vehicle.

As shown by block 606, the method 600 also includes displaying the score of the review of the passenger trip. In one example, the input/output module 302 of FIG. 3 is configured to provide an instruction for displaying, via a display screen, the score of the review of the passenger trip. It is envisioned that the score may be displayed with one or more visual effects.

In one embodiment, the method 600 may further include receiving, via one or more input devices, a selection of a vehicle based on the score. In one example, the selection may occur via a touchscreen of a mobile device. In another example, the selection may occur with the aid of a keyboard and a mouse of a computing device. In one example, the selection may occur through a voice command associated with an electronic device.

In one embodiment, the method 600 may further include receiving sensor data that corresponds to the passenger trip in the vehicle. Continuing with this embodiment, the method 600 may further include determining a score of the review based on the received sensor data and an analysis of the review. In another embodiment, the method 600 may further include receiving traffic data that corresponds to the passenger trip in the vehicle. Continuing with this embodiment, the method 600 may further include determining a score of the review based on the received traffic data and an analysis of the review. In one embodiment, the method 600 may further include receiving route data that corresponds to the passenger trip in the vehicle. Continuing with this embodiment, the method 600 may further include determining a score of the review based on the received route data and an analysis of the review. In another embodiment, the method 600 may further include receiving weather data that corresponds to the passenger trip in the vehicle. Continuing with this embodiment, the method 600 may further include determining a score of the review based on the received weather data and an analysis of the review.

The processes described herein for evaluating a review of a passenger trip may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

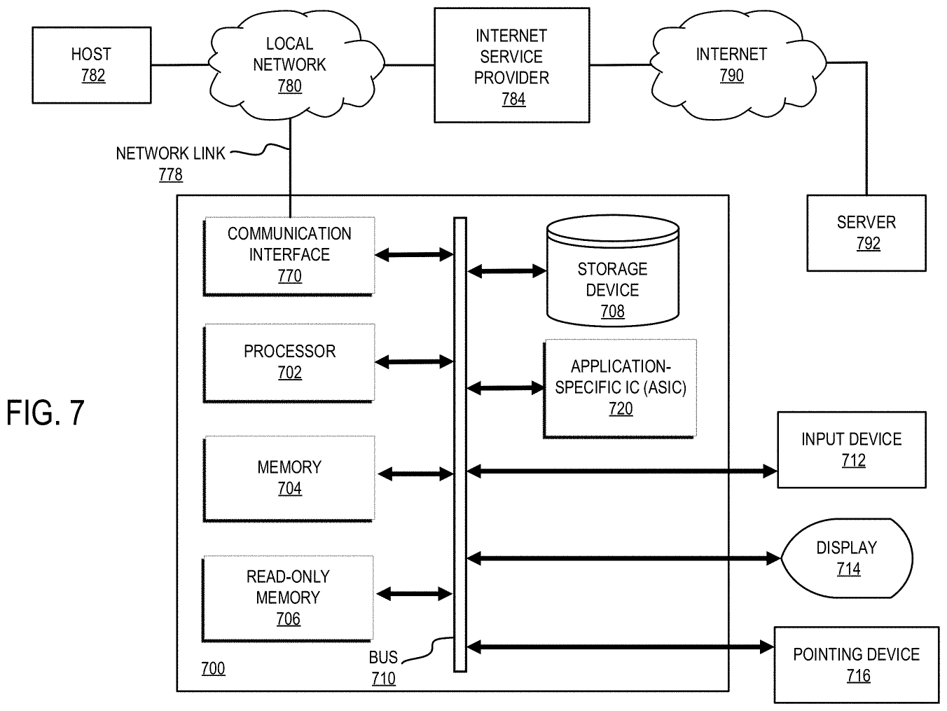

FIG. 7 illustrates a computer system 700 upon which an embodiment may be implemented. Computer system 700 is programmed (e.g., via computer program code or instructions) to provide information for evaluating a review of a passenger trip as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to evaluating a review of a passenger trip. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for evaluating a review of a passenger trip. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for evaluating a review of a passenger trip, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 700 may also include one or more instances of a communications interface 770 coupled to bus 710. The communication interface 1170 may provide a one-way or two-way communication coupling to a variety of external devices that operate with their own processors, such as printers, scanners and external disks. In addition, the communication interface 770 may provide a coupling to a local network 780, by way of a network link 778. The local network 780 may provide access to a variety of external devices and systems, each having their own processors and other hardware. For example, the local network 780 may provide access to a host 782, or an internet service provider 784, or both, as shown in FIG. 7. The internet service provider 784 may then provide access to the Internet 790, in communication with various other servers 792.

Computer system 700 also includes one or more instances of a communication interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, the communication interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, the communication interface 770 may be a local area network (LAN) card to provide a data communication connection to a compatible LAN, such as Ethernet. Wireless links may also be implemented. For wireless links, the communication interface 770 sends or receives or both sends and receives electrical, acoustic or electromagnetic signals, including infrared and optical signals, that carry information streams, such as digital data. For example, in wireless handheld devices, such as mobile telephones like cell phones, the communication interface 770 includes a radio band electromagnetic transmitter and receiver called a radio transceiver. In certain embodiments, the communication interface 770 enables connection to the communication network 115 of FIG. 1 for providing information for evaluating a review of a passenger trip.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

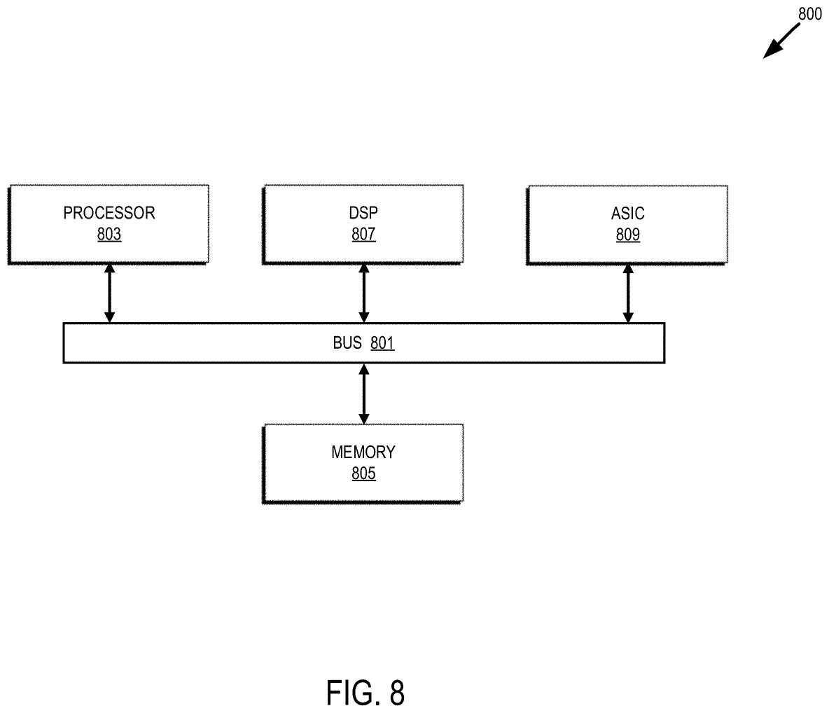

FIG. 8 illustrates a chip set 800 upon which an embodiment may be implemented. Chip set 800 is programmed to evaluate a review of a passenger trip as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the steps described herein to provide information for evaluating a review of a passenger trip. The memory 805 also stores the data associated with or generated by the execution of the inventive steps.

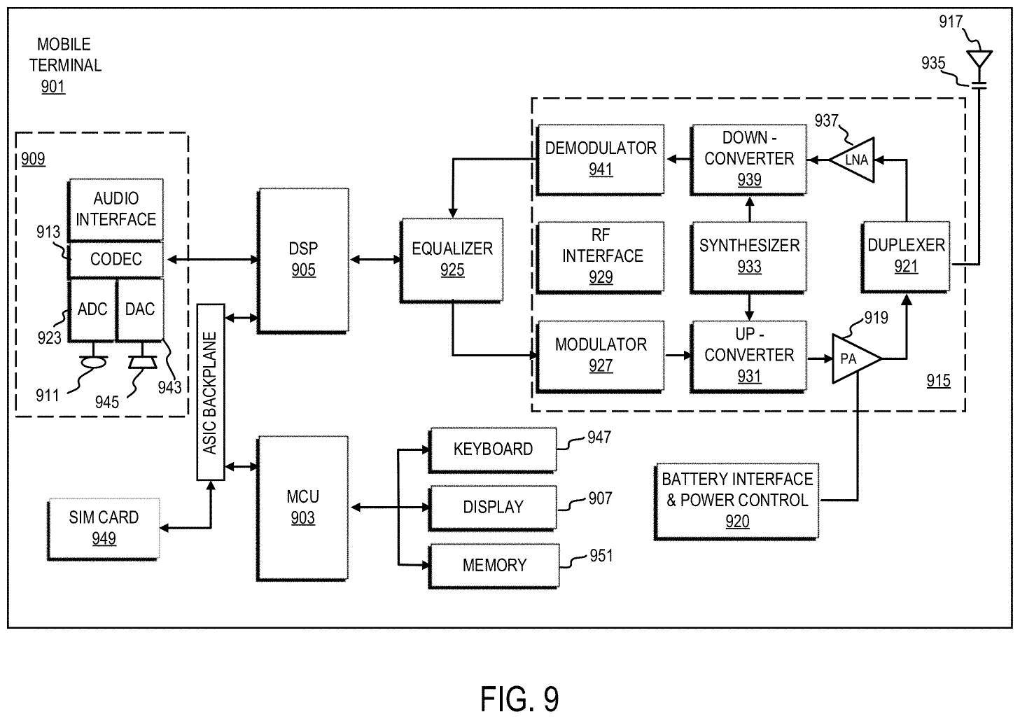

FIG. 9 is a diagram of exemplary components of a mobile terminal 901 (e.g., a mobile device, vehicle, and/or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 1320.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to provide information for evaluating a review of a passenger trip. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

We (I) claim:

1. A method for evaluating a review of a passenger trip, the method comprising:
analyzing the review of the passenger trip in a vehicle;
receiving sensor data that corresponds to the passenger trip; and
determining a score of the review based on the received sensor data and the analysis of the review.

2. The method of claim 1, further comprising:
receiving traffic data that corresponds to the passenger trip;
analyzing the traffic data based on the review of the passenger trip; and
updating the determined score of the review based on the analysis of the traffic data.

3. The method of claim 1, further comprising:
receiving route data that corresponds to the passenger trip;
analyzing the route data based on the review of the passenger trip; and
updating the determined score of the review based on the analysis of the route data.

4. The method of claim 1, further comprising:
receiving weather data that corresponds to the passenger trip;
analyzing the weather data based on the review of the passenger trip; and
updating the determined score of the review based on the analysis of the weather data.

5. The method of claim 1, wherein the sensor data includes one or more measurements of motion data that corresponds to an operation of the vehicle.

6. The method of claim 1, wherein the sensor data includes one or more measurements of safety data that corresponds to an operation of the vehicle.

7. The method of claim 1, wherein the review is based on passenger behavior during the passenger trip.

8. A non-transitory computer-readable storage medium comprising one or more sequences of one or more instructions for execution by one or more processors of a device, the one or more instructions which, when executed by the one or more processors, cause the device to:
analyze a review of a passenger trip in a vehicle;
receive traffic data or route data, or a combination thereof, based on the analysis of the review; and
determine a score of the review based on the traffic data or the route data, or the combination thereof, and the analysis of the review.

9. The non-transitory computer-readable storage medium of claim 8, wherein the one or more instructions which, when executed by the one or more processors, further cause the device to:
receive weather data that corresponds to the passenger trip;
analyze the weather data based on the review of the passenger trip; and
update the determined score of the review based on the analysis of the weather data.

10. The non-transitory computer-readable storage medium of claim 8, wherein the one or more instructions which, when executed by the one or more processors, further cause the device to:
receive sensor data that corresponds to the passenger trip;
analyze the sensor data based on the review of the passenger trip; and
update the determined score of the review based on the analysis of the sensor data.

11. The non-transitory computer-readable storage medium of claim 10, wherein the sensor data includes one or more measurements of motion data that corresponds to an operation of the vehicle.

12. The non-transitory computer-readable storage medium of claim 10, wherein the sensor data includes one or more measurements of safety data that corresponds to an operation of the vehicle.

13. The non-transitory computer-readable storage medium of claim 8, wherein the review is based on passenger behavior during the passenger trip.

14. An apparatus for evaluating a review of a passenger trip, the apparatus comprising:
a processor; and
a memory comprising computer program code for one or more programs, wherein the memory and the computer program code is configured to cause the processor of the apparatus to:
receive the review of the passenger trip in a vehicle;
determine a score of the review of the passenger trip in the vehicle; and
provide for a display of the score of the review of the passenger trip.

15. The apparatus of claim 14, wherein the computer code is configured to further cause the processor of the apparatus to:
receive, via one or more input devices, a selection of a vehicle based on the score.

16. The apparatus of claim 14, wherein the computer code configured to cause the processor of the apparatus to determine the score of the review of the passenger in the vehicle is configured to further cause the processor of the apparatus to:
receive sensor data that corresponds to the passenger trip in the vehicle; and
determine a score of the review based on the received sensor data and an analysis of the review.

17. The apparatus of claim 14, wherein the computer code configured to cause the processor of the apparatus to determine the score of the review of the passenger in the vehicle is configured to further cause the processor of the apparatus to:
receive traffic data that corresponds to the passenger trip in the vehicle; and
determine a score of the review based on the traffic data and an analysis of the review.

18. The apparatus of claim 14, wherein the computer code configured to cause the processor of the apparatus to determine the score of the review of the passenger in the vehicle is configured to further cause the processor of the apparatus to:
receive route data that corresponds to the passenger trip in the vehicle; and
determine a score of the review based on the route data and an analysis of the review.

19. The apparatus of claim 14, wherein the computer code configured to cause the processor of the apparatus to determine the score of the review of the passenger in the vehicle is configured to further cause the processor of the apparatus to:
receive weather data that corresponds to the passenger trip in the vehicle; and
determine a score of the review based on the weather data and an analysis of the review.

20. The apparatus of claim 14, wherein the review is based on passenger behavior during the passenger trip.
